(19) United States
(12) Patent Application Publication
(10) Pub. No.: US 2015/0056075 A1
(43) Pub. Date: Feb. 26, 2015

(54) WIND TURBINE

(71) Applicant: Ofer Birarov, (US)

(72) Inventor: Ofer Birarov, Ein Yaacov (IL)

(21) Appl. No.: 14/381,602

(22) PCT Filed: Feb. 28, 2013
(86) PCT No.: PCT/IL2013/050175

§ 371 Date: Aug. 28, 2014

(30) Foreign Application Priority Data
Mar. 1, 2012 (IL) 218451

(51) Int. Cl. F03D 9/00; F03D 11/02

(52) U.S. Cl. CPC F03D 9/003; F03D 11/02
USPC 416/1; 416/146 R

(57) ABSTRACT

A device and method to generate electricity via a wind turbine. The device includes a first stator ring or a portion thereof, a second rotor comprising a ring encircling a set of blades, and wherein a rotation of the second rotor ring with respect to the first stator ring or the portion thereof generates energy.

### FIELD OF THE INVENTION

This relates to the field of energy generation via wind turbines. In particular the generation of electricity via horizontal-axis wind turbines.

### BACKGROUND

Typically, wind turbines are configured to convert kinetic energy from the wind into mechanical energy. Typically, the mechanical energy is used to produce electrical energy for an electrical grid. In some examples, wind turbines rotate a set of large blades in response to a wind, the blades coupled to a central hub. Wind turbines may have at least one or a plurality of gearboxes coupled to these large blades and the central hub due to low angular velocity of the hub in response to the rotation of the blades. The gearbox typically functions such that even slow rotations of the large blades can be converted, via the gearbox, to higher rotations within a generator, the generator typically configured to sit within a space at the center of the wind turbine.

Wind turbines are generally designed with the exploitation of local wind energy, e.g., a generating air flow, in mind Wind turbines typically include a support structure; often the location of the wind turbine or structural design necessitates a very tall structure, a rotor and blade unit, and the generator unit configured to convert the rotation of the blades into electrical energy. The generator is typically mounted in a nacelle, i.e., a relatively large housing, at the top of a support structure, behind the hub of the turbine rotor.

Aerodynamic modeling is typically used to determine the optimum height, control and blade shape of the turbine. Blade design is an essential component in wind turbine design and economics. Wind turbines often include a large footprint, given the wingspan of their blades. Blade speeds are typically limited due to air density near the speed of sound. Typically, the slower a blade rotates the less energy it can produce.

Wind turbines, by their nature, are very tall and slender structures often necessitating specific structural designs for the foundations that must both deal with vertical and horizontal loads. Support structure heights tend to be a multiple of the blade length; typically, blades have a length ⅔ the height of the support structure. Taller support structures or masts, as well as longer blades, not only create unsightly eyesores, visible from greater distances, but they increase transportation and installation costs, often rivaling the costs of some of the parts of the apparatus.

### SUMMARY

In some examples, a wind turbine is constructed with concentric rings that may not necessitate the typical support structure height. The center ring in the wind turbine may allow non turbulent wind to pass through to downstream wind turbines.

Typically, a wind turbine apparatus includes an outer ring, or portion thereof coupled to a support structure, the support structure having a top, a movable inner ring configured to rotate within the outer ring, a center ring coupled to a set of blades, the set of blades configured to rotate within the inner ring in response to wind, and wherein the rotating of the movable inner ring within the outer ring generates electricity.

In some examples, the outer ring may be coupled to the support structure, above the top of the support structure.

In some examples, the outer ring may contain a set of coils configured to conduct electricity.

In some examples, a movable inner ring may contain a set of magnets, e.g., electromagnets, the magnets configured to rotate past a set of coils in the outer ring.

In some examples, the center ring may be configured to allow wind to pass through unimpeded.

In some examples, the wind turbine may be configured to be placed in a body of water.

In some examples, the blades of the wind turbine may be configured to rotate above the top of the support structure.

In some examples, the outer ring may be configured to be static relative to the support structure.

In some examples, the outer ring is configured to rotate relative to the support structure.

Typically, a method for converting kinetic energy to electrical energy, according to an example includes, includes rotating a movable inner ring within a static outer ring, or portion thereof, rotating a set of blades, typically connected to a center ring, within the inner ring; and, allowing wind to pass through a void, typically a hollow portion of a center ring, and minimizing impediments to air flow.

In some examples, electricity may be generated by passing at least one magnet in the inner ring past a set of coils in the outer ring.

In some examples, the set of blades may rotate above a top of a support structure.

### BRIEF DESCRIPTION OF THE DRAWINGS

The subject matter regarded as the invention is particularly pointed out and distinctly claimed in the concluding portion of the specification. Embodiments of the invention, however, both as to organization and method of operation, together with objects, features, and advantages thereof, may best be understood by reference to the following detailed description when read with the accompanying drawings in which:

FIG. 1A is a schematic illustration of an example of a wind turbine apparatus according to an example;

FIG. 1B is a schematic illustration of an example of a wind turbine apparatus according to an example;

FIG. 2 is a schematic illustration of a cross section of an example of a wind turbine and down stream wind turbines, according to an example;

FIG. 3 is a schematic of the electrical generating portion of a wind turbine, according to an example; and,

FIG. 4 is a flow chart of a method of generating electricity via a wind turbine, according to an example.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

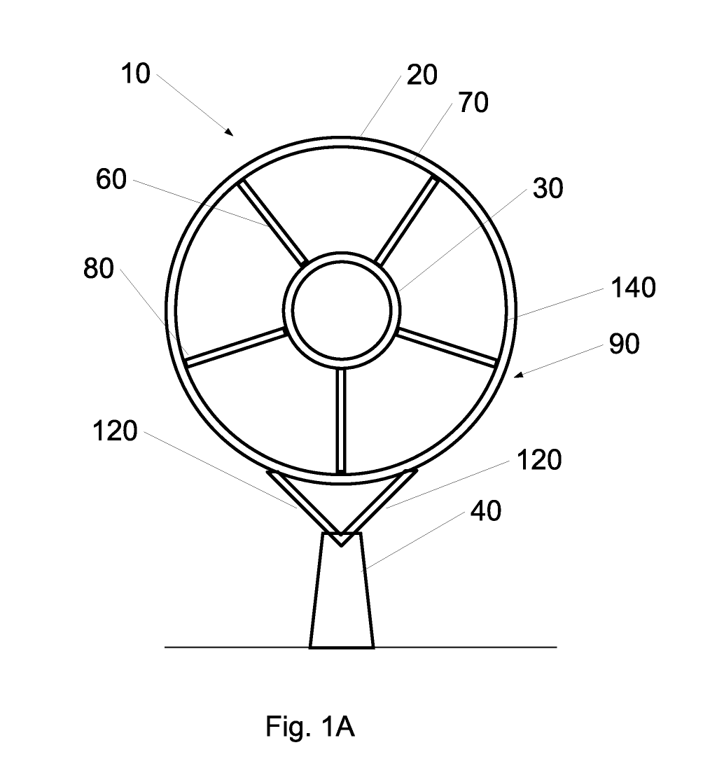

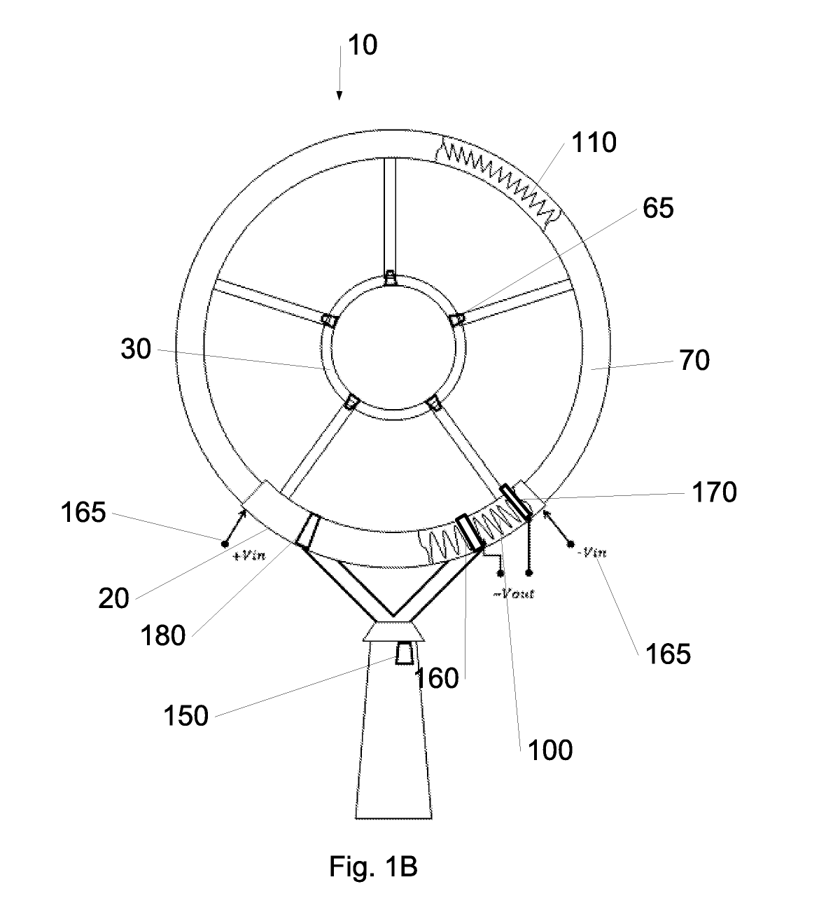

FIG. 1A is a schematic illustration of an example of a wind turbine apparatus. Wind turbine 10 typically includes three concentric rings, an outer ring 20, a movable inner ring 70, and a center ring 30. In some examples, there may be an alternative to a center ring. In some examples, there may be a non-hollow center structure.

Outer ring 20 may be configured to act as a stator. In some examples, outer ring 20 may to be static, and may be coupled to a support structure 40. In some examples, outer ring 20 may be movable. In some examples, outer ring 20 may be only a portion of a ring, as described below.

Typically, outer ring may be coupled to support structure 40. In some examples, outer ring 20 is coupled to the support structure above the top of support structure 40. In some examples, outer ring 20 may be coupled to support structure 40 such that support structure 40 is configured to minimize the impedance of air flow to and away from a set of blades, the blades described below.

In some examples, a generator may be configured to be connected to outer ring 20. In some examples, outer ring may be a component of a generator 50, as described below.

Typically, outer ring 20 has a diameter of between 100-200 meters, e.g., 150 meters. In some examples, outer ring may have a larger or smaller diameter.

In some examples, outer ring 20 may be connected to support structure 40 by one or a plurality of members. The members may be constructed from materials as are known in the art.

Typically, the members may be one or a plurality of struts 120, may be configured in a V formation to support the outer ring. In some examples, struts 120 may be configured in an alternative formation to support the outer ring. In some examples, outer ring 20 may be connected to support structure 40 by other methods known in the art.

In some examples, outer ring 20 may be constructed of at least steel or composite materials. In some examples, other materials known in the art may be used.

In some examples, inner ring 70 may be configured to act as a rotor in a generator. In some examples, inner ring 70 may be constructed of at least steel or composite materials. In some examples, other materials known in the art may be used.

Typically, wind turbine 10 includes a set of blades, the set of blades including one or more blades 60, are configured to be attached to center ring 30. In some examples, there are between two and seven blades 60, e.g., five blades, connected to center ring 30. In some examples, there may be greater or fewer blades attached to center ring 30. In some examples, blades 60 may be attached to a central point. In some examples, blades 60 may be attached to a central structure, as described below. In some examples, the central structure may have a void, as described below.

In some examples, blades 60 may be attached to center ring via motors 65, the motors configured to rotate blades 60, such that they are better able to rotate inner ring 70 at a particular speed. In some examples, motor 65 rotate blades 60 in response to the direction and/or force of the wind.

Blades 60 are typically shaped like wind turbine blades that are known in the art. Blades 60 are typically constructed from materials known in the art. In some examples, one or a plurality of blades 60 may change their pitch to accommodate different wind speeds and directions. In some examples, other aspects of blade 60 may change to accommodate environmental factors, or for other needs known in the art.

Typically, center ring 30 may include drivers, e.g., motors 65, as are known in the art, to control and/or maintain the change of the pitch of one or a plurality of blades 60.

Typically, blades 60 may have a length of between 40 and 100 meters, e.g., 70 meters. Other blade lengths that are longer or shorter may also be used as are known in the art.

Typically, blade 60 may have a tip 80. Tip 80 may have two or more sides. Typically, one side of tip 80 may face the wind.

Typically, the speed of rotation of tip 80 is distinct (i.e., faster) than the speed of rotation at the other end of the blade 60, the other end, closer to the center of wind turbine 10. Typically, the relationship between the two may be measured by the tips speed ratio, as is known in the art.

An outer ring unit 90 may be composed of two separate rings, an outer ring 20 and a movable inner ring 70. Typically, inner ring 70 may be coupled to one or a plurality of blades 60, and may be configured to rotate with blades 60.

Typically, outer ring 20 and inner ring 70 are close together. Typically, there may be a gap 140 between inner ring 70 and outer ring 20.

In some examples, gap 140 may be maintained via ball bearings between outer ring 20 and inner ring 70. Typically, gap 140 may be maintained via a cushion of air, typically, a cushion of compressed air. In some examples, the compressed air for the cushion of compressed air may exit through holes in outer ring 20 to create the cushion of air between inner ring 70 and outer ring 20. In some examples, compressed air may exit through holes in inner ring 70 to create the cushion of air. In some examples, other methods of maintaining gap 140, as are known in the art, may also be employed.

In some examples, blades 60 may be configured to rotate clockwise. In some examples, blades 60 may be configured to rotate counterclockwise. In some examples, blades 60 may be configured to rotate either clockwise or counterclockwise. In some examples, blade rotation may depend on the wind.

In some examples, as one or a plurality of blades 60 rotate, a pressure gradient may form on either side of tips 80, the pressure gradient typically the result of high pressure on a first side of one or a plurality of blades 60 and low pressure on a second side of one or a plurality of blades 60. Configured to help minimize or limit the development of vortices at tips 80 and the potential resulting air turbulence resulting from the pressure gradient, blade 60 may be typically configured to be in close proximity to inner ring 70, typically attached to inner ring 70, the close proximity configured to prevent or limit movement of air down the pressure gradient and around tip 80.

Typically, center ring 30 has a diameter of between approximately 20% to 40%, e.g., 25% to 33%, of the diameter of outer ring 20. Typically, center ring 30 may be configured to allow most wind to pass through uninhibited.

In some examples, the wind may pass through center ring 30 wholly uninhibited, e.g., minimizing turbulent air or wakes to downstream wind turbines. In some examples, the passage of wind through center ring 30 may allow individual wind turbines, typically individual wind turbines on wind farms, as are known in the art, to be placed more closely together, as described below,

Typically, appropriate spacing between turbines may be dependent on terrain and wind rose for a particular site. In some examples, the design of wind turbine 10, and the minimization of wake due to center ring 30 allows other wind turbines to be spaced closer than current average spacing in the art.

In some examples, the typical availability of turbulence and wake free air, resulting from air passing through center ring 30, may generally reduce mechanical loads on wind turbine 10, on downstream turbines, and on support structure 40 of wind turbine 10 and on other support structures of other wind turbines that may be situated in close proximity to wind turbine 10.

Typically, support structure 40 may provide clearance between blades 60 and the ground. In some examples, support structure may rotate in such a way as to rotate the rings toward the wind.

The construction of wind turbine 10 may allow for a shorter support structure 40 than other support structures known in the art, and that may be typical in the art. In some examples, the support structure can be up to 33% shorter than support structures of similarly sized wind turbines that are known in the art. In some examples, support structure 40 may support the entirety, or most of the length of blade 60 above the top of support structure 40.

Support structure 40 may be configured to be placed on the ground or in a body of water.

Typically, with the entirety, or in some examples, most of the length of one or a plurality of blades 60 sitting above a top of support structure, air may move freely to a large portion of one or a plurality of blades 60, in some examples, air may move freely to the majority of one or a plurality of blades 60. In some examples, air may move freely, i.e., with limited or no impediments, to all of one or a plurality of blades 60.

In some examples, air may move feely, and may not be substantially obstructed by support structure 40. The movement of air without being substantially obstructed by support structure 40 may be configured to reduce vibrations that may result if a support structure were to be placed in-between an upstream wind and one or a plurality of blades 60. In some examples, most upstream air used by wind turbine may move feely, and may not be obstructed by support structure 40.

In some examples, the placement of support structure 40 below a projected path of one or a plurality of blades 60 may be configured to reduce the development of a dynamic pressure gradient in the area where one or a plurality of blades 60 would otherwise cross in front of upstream air that may have encountered support structure 40 first.

Typically, with wind turbine 10 configured to allow non-turbulent wind to reach most of one or a plurality of blades 60, and in some examples, configured to allow non-turbulent wind to reach the entirety of one or a plurality of blades 60, and with the reduction of vortices at tips 80 of blade 60, a large portion of the surface area of one or a plurality of blades 60, in some examples, most of the surface of one or a plurality of blades 60, may be harnessed to convert kinetic energy to electricity or other forms of usable energy. In some examples, all of the surface of one or a plurality of blades 60 may be harnessed to convert kinetic energy to electricity or other forms of commercially usable energy.

Typically, to harness kinetic energy and convert that energy to electrical energy, generator 50 may include outer ring 20 and inner ring 70. Typically, outer ring 20 may serve as the housing for a stator and inner ring 70 may serve as housing for a rotor for electrical generator 50.

In some examples, energy is produced as a result of the inner ring 70 spinning around within outer ring 20, or a portion thereof. Typically, inner ring 70, coupled to tips 80, typically may spin faster than center ring 30 coupled to an opposite end of blade 60 as described above, as is known in the art.

With the relevant speed for producing energy typically at tips 80, and typically not at center ring 30, wind turbine 10 may be able to generate more electricity at low wind speeds than had wind turbine 10 generated energy via the rotations of center ring 30, or in some examples, if wind turbine 10 had a hub attached to a gearbox at the confluence of one or a plurality of blades 60 at the center of wind turbine 10.

Typically, there is no gearbox when energy is generated as a result of the rotation of inner ring 70 coupled to tips 80; the current generating inner ring 70 may be typically rotating at or near the speed of tips 80.

The lack of a gearbox may minimize the amount of regular maintenance necessary to upkeep wind turbine 10. In some examples, a reduction in regular maintenance and upkeep may allow wind turbine 10 to be placed in remote locations and may reduce other long term costs associated with wind turbines, as are known in the art.

Typically, wind turbine 10 may produces a lesser amount of torque as the wind rotates one or a plurality of blades 60 when power is generated at tips 80, than when power may be generated as a result of the rotation of center ring 30, or in some examples, if wind turbine 10 had a hub attached to a gearbox at the confluence of one or a plurality of blades 60 at the center of the turbine.

In some examples, when wind turbine produces less torque, there may be less stress on outer ring 20. In some examples, there may be less stress on other components of wind turbine 10. Typically, when there is less stress on outer ring 20, wind turbine 10 may not need as much maintenance. In some examples, when there is less torque produced by spinning one or a plurality of blades 60, there may be less stress on support structure 40.

In some examples, when wind turbine 10 lacks a gearbox, this may reduce the vertical load on support structure 40.

In some examples, wind turbine may have a braking system, as described below.

FIG. 1B is a schematic illustration of a wind turbine, according to an example.

In some examples, outer ring 20 may be only a portion of a ring. In some examples, outer ring 20 may be a sleeve-like structure through which inner ring 70 rotates. In some examples, outer ring 20 may be a portion of a ring between 10-90 degrees of a circle, e.g., 45 degrees.

Typically, when outer ring 20 is only a sleeve like structure it may be coupled to struts 120. Struts 120 may be coupled to support structure 40. Support structure 40 may house a control unit 150. Typically, control unit 150 may be involved in orienting wind turbine 10, blades, 60 and/or rings 20, 70 and 30 toward the wind and other functions of wind turbine 10 as known in the art.

In some examples, a solenoid or coils 100, described below, may be incorporated into the outer ring 20 sleeve structures.

In some examples, a movable and/or slidable electrode 160, e.g., an electrode that can act as a variator to change the parameters of the wind turbine's generation of energy, and in some applications, the effective length of the coil, may be positioned to move along the length of coil 100, the coil having opposite ends. In some examples, there may be a second electrode 170, either fixed or movable, at or near an opposite end of the coil 100. Typically, the two electrodes allow energy to be collected and distributed out of wind turbine 10.

As described below, a moving electromagnet 110 in inner ring 70 may generate voltage, typically via inductance, as it passes past coil 100. In some examples, slidable electrode 160 may move toward or away from second electrode 170, the distance between the electrodes being related to the eventual and/or desired voltage generated by the wind turbine. Typically, as the electrodes are positioned further away from each other, a greater amount of torque, in some examples, the torque generated via the wind, may be necessary to move electromagnets 110 past coil 100.

In examples where there is less wind in the environment, the electrodes may be positioned closer to each other, requiring less torque to generate a voltage, the voltage being converted into a generated energy output, typically electricity, as described below.

In some examples, wind turbine 10 may have an external power unit 165 for providing external or non-generated electricity to power components of wind turbine 10. Typically, external power unit may connect to wind turbine 10 via electrodes 165. In some examples electrodes 165 may be a positive terminal, +Vin, and a negative terminal, −Vin, coupled to wind turbine 10, in some examples, coupled to outer ring 20 Powered components may include motors 65, movable and/or slidable electrode 160, and electromagnets 110. Other components that may be powered by external electricity unit 165, as are known in the known in the art, may also be connected to, and powered by, external electricity unit 165.

In some examples, wind turbine may have a braking system 180 similar to rim brakes on a bicycle. In some examples, the rim brakes may be similar to one or more of the following bicycle brake designs, including: rod-actuated brakes, caliper brakes, side-pull caliper brakes, center-pull caliper brakes, U-brakes, cantilever brakes, V-brakes, rollercam brakes, delta brakes, hydraulic rim brakes, and/or other brakes known in the art. Typically, the brakes are near the portion of the windmill where outer ring 20, or a portion thereof, is near structure 40.

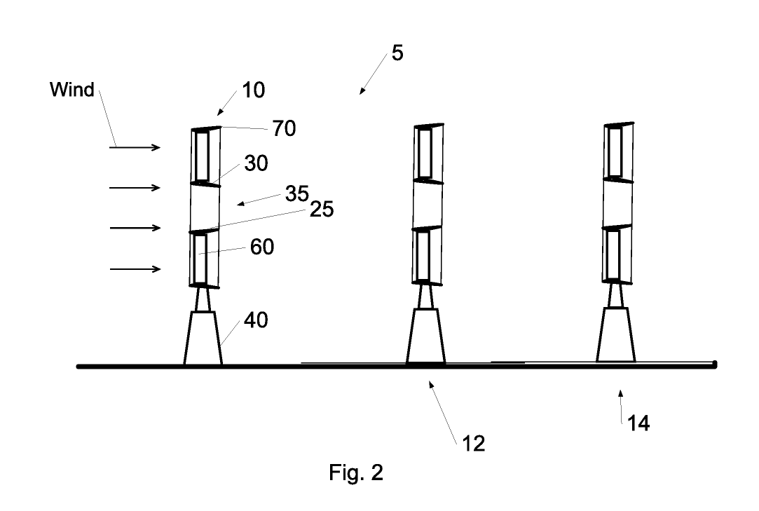

FIG. 2 is a schematic illustration of a cross section of a wind turbine, on a wind farm according to an example.

Typically, wind turbine may be on a wind farm 5 where there may be one or a plurality of additional wind turbines, here depicted as wind turbines 12 and 14.

Wind turbines 10, 12, and 14 are depicted on flat ground and at the same level and height for illustrative purposes only.

Typically, center ring 30 may be configured, in some examples, to provide a clear and uninterrupted central air flow through wind turbine 10, typically through a central void 35 in center ring 30. In some examples, the central void may be independent of center ring 30 and may be surrounded by a holding structure 25. In some examples, the holding structure for central void 35 is center ring 30. This may facilitate a downstream arrangement of a plurality of wind turbines in relatively close formation because of the uninterrupted central air flow that quickly regains its kinetic energy.

Typically, downstream wind turbines, e.g., wind turbines 12 and 14 may be placed closer together when wind turbine 10 has center ring 30.

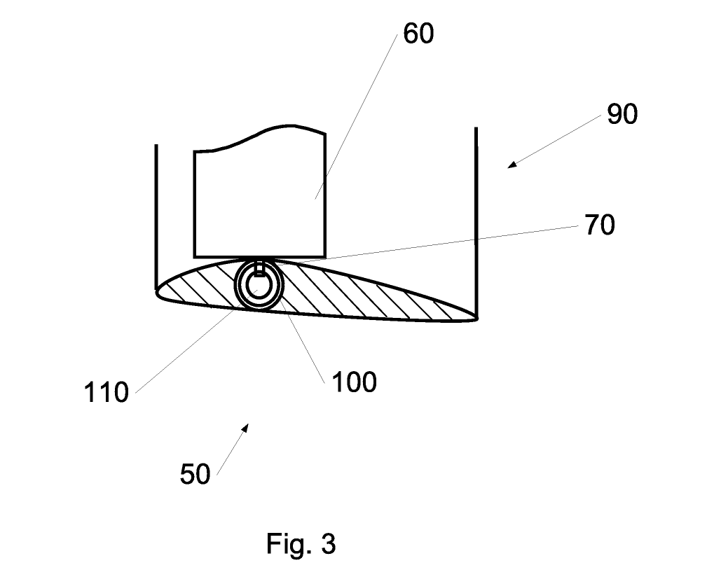

FIG. 3 is a schematic illustration of a cross section of an energy generating portion of the wind turbine, according to an example.

Typically, outer ring 20 may contain a set of coils or solenoids, the set of coils including one or a plurality of coils 100. Coils 100 may be similar in function to field coils or field windings as are known in the art. In some examples, outer ring 20 may contain a set of coils 100 in a small portion of a circumference of outer ring 20. In some examples, outer ring 20 may contain a set of coils in a portion of the circumference of outer ring 20 wherein the portion of the circumference is near support structure 40. In some examples, outer ring 20 contains coils throughout a large portion of the ring. In some examples, outer ring 20 contains coils throughout the entirety ring.

Typically, the size of the coils 100 in outer ring 20 may result in more or less torque resistance against moving inner ring 70. In some examples, the orientation of one or plurality of blades 60 may also result in less torque resistance. In some examples, the effective length of coil 100 may be varied by variators and/or movable electrodes, as described above.

In some examples, inner ring 70 may have one or a plurality of magnets, typically, electromagnets 110 within the structure of inner ring 70. In some examples, said one or a plurality of electromagnets 110 may be configured to be coupled to an outer surface of inner ring 70. In some examples, said one or a plurality of electromagnets 110 may be configured to be coupled to an inner surface of inner ring 70.

Typically, said one or pluralities of electromagnets are configured to be placed throughout the circumference of inner ring 70. In some examples, electromagnets 110 are configured to be evenly placed throughout circumference of inner ring 70. In some examples, one or plurality of electromagnets 110 are placed in only specific portions of inner ring 70.

Typically, electricity is generated by passing electromagnets in inner ring 70 past the set of coils 100 in outer ring 20. As inner ring 70 spins in conjunction with one or a plurality of blades 60, the coupled electromagnets will pass over the area of outer ring 20 where coils 100 are configured to be coupled.

In some examples, electricity may be generated by passing set of coils 100 in inner ring 70 past electromagnets 110 in outer ring 20.

When said one or plurality of electromagnets 110 move past the set of coils, the resulting changes in the magnetic field may lead to the creation of electricity, as is known in the art. As the magnetic field around coil 100 changes, voltage may be induced within coil 100, as is known in the art.

As is known in the art, the voltage may drive electrical current. In some examples, the current may be alternating current. In some examples, the alternating current is sent out of wind turbine 10 through power lines for distribution. In some examples, the current is stepped down, as is known in the art, for greater efficiency in transmission of the electricity through a power grid.

Typically, an output voltage from wind turbine 10 is a result not of the speed of one or a plurality of blades 60, but rather the speed of the movement of electromagnets 110 past the coils 100, their size, and the magnetic field intensity of the stator, i.e., typically electromagnets 110 in inner ring 70.

A faster-moving electromagnet 110 may induce a greater amount of voltage, as is known in the art. Typically, the speed of rotation may be limited. In some applications, rotation of one or a plurality of blades 60 within wind turbine 10 maybe configured to be slower than the speed of sound.

In some examples, structural constraints in support structure 40 and/or other components of wind turbine 10 may limit the torque output of wind turbine 10. In some examples, the design of wind turbine 10 may reduce torsional forces on support structure 40. In some examples, this reduced torsional force may allow for alternatives in the construction of support structure 40.

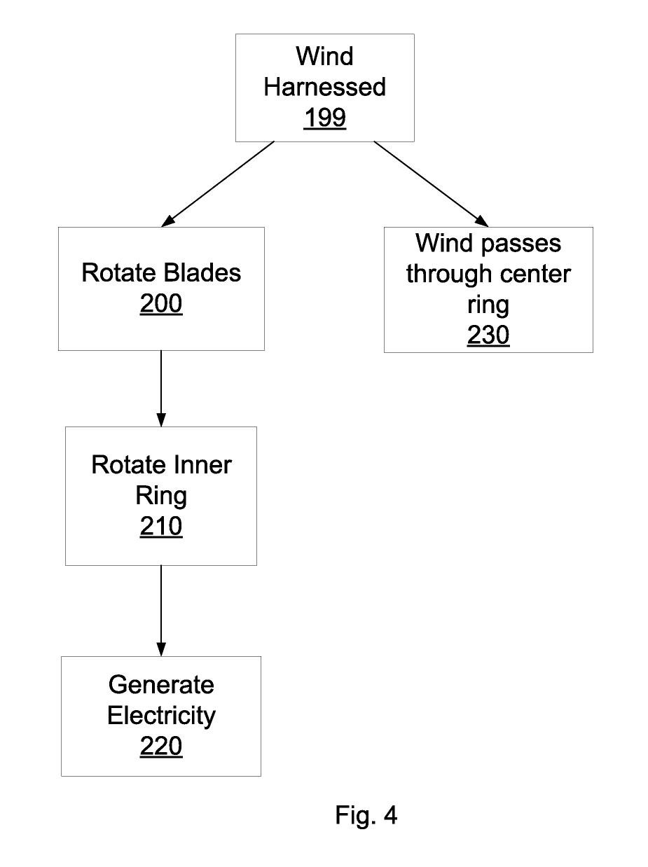

FIG. 4 is a flow chart of a method for generating electricity via wind turbine 10, according to an example. Typically, wind turbine 10 is operational and generating energy when the wind is blowing. The wind may be harnessed by wind turbine 10, as depicted by block 199. In some examples, the wind is harnessed by blades 60 to rotate inner ring 70 within outer ring 20, or a portion thereof. In some examples, the wind is harnessed by central ring 30, where central ring 30, allows for the passage of the wind downstream to downstream wind turbines.

In some examples, a set of one or a plurality of blades 60 connected to an inner ring 70 is rotated, as depicted by block 200. Typically, a movable inner ring 70 is rotated within a static outer ring 20, as depicted by block 210. The rotation of inner ring 70 containing electromagnets 110 within outer ring 20 containing a conducting coil 100 typically results in the generation of energy which may be converted into electricity, as depicted by block 220. In some examples, the rotation of inner ring 70 containing a conducting coil 100 within an outer ring 20 containing electromagnets 110 may typically result in the generation of electricity. When rotating inner ring 70 within outer ring 20, wind turbine 10 is typically configured to allow wind to pass through central ring 30, as depicted by block 230. Typically, when wind is allowed to pass through central ring 30, impediments to downstream air flow may be minimized.

Features of various embodiments discussed herein may be used with other embodiments discussed herein. The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

What is claimed is:

1. A wind turbine device for generating energy, the device comprising:
a first stator ring or a portion thereof;
a second rotor comprising a ring encircling a set of blades; and,
wherein a rotation of the second rotor ring with respect to the first stator ring or the portion thereof generates energy.

2. The device of claim 1, wherein the energy is generated by inductance.

3. The device of claim 2, comprising one or more electromagnets and one or more coils.

4. The device of claim 3, wherein said one or more electromagnets is coupled to the second rotor ring and said one or more coils is coupled to the first stator ring.

5. The device of claim 3, wherein said one or more coils comprises a variator for varying an effective length of said one or more coils.

6. The device of any of claims 1 through 5, wherein the set of blades of the second rotor wing converge so as to leave a central void.

7. The device of claim 6, wherein the set of blades converge to a holding structure comprising the central void.

8. The device of claim 7, wherein the holding structure comprises a ring.

9. The device of any of claims 1 through 8, comprising a support structure that supports the first stator ring or the portion thereof.

10. The device of claim 9, wherein the support structure is configured so as to be away from a generating air flow.

11. The device of any of claims 1 through 10, comprising a braking system for braking the second rotor ring.

12. The device of any of claims 1 through 11, wherein a rotation of the second rotor ring with respect to the first stator ring is configured to be directly translated into the generated energy.

13. A method for generating energy comprising:
operating a wind turbine that comprises a first stator ring or a portion thereof, and a second rotor comprising a ring encircling a set of blades and allowing air flow to rotate the second rotor ring with respect to the first stator ring so as to generate energy.

14. The method of claim 13, wherein the energy is generated by inductance.

15. The method of claim 14, comprising using one or more electromagnets and one or more coils.

16. The method of claim 15, wherein said one or more electromagnets is coupled to the second rotor ring and said one or more coils is coupled to the first stator ring.

17. The method of claim 15, wherein said one or more coils comprises a variator for varying an effective length of said one or more coils and wherein the method comprises using the variator to vary a generated energy output of the wind turbine.

18. The method of any of the claims 13 through 17, wherein the set of blades of the second rotor wing converge so as to leave a central void.

19. A method for generating energy comprising:
operating a plurality of wind turbines, each of the wind turbines comprising a first stator ring or a portion thereof, and a second rotor comprising a ring encircling a set of blades and allowing air flow to rotate the second rotor ring with respect to the first stator ring so as to generate energy, wherein at least one of the wind turbines is placed downstream with respect to another of the wind turbines.
